(19) United States
(12) Patent Application Publication
(10) Pub. No.: US 2025/0078383 A1
(43) Pub. Date: Mar. 6, 2025

(54) ACCELERATING THREE-DIMENSIONAL FINITE-DIFFERENCE TIME-DOMAIN ELECTROMAGNETIC SIMULATION USING A MIRRORED GPU DOMAIN

(71) Applicant: Dermot Thomas Heneghan, Laurel, MD (US)

(72) Inventor: Dermot Thomas Heneghan, Laurel, MD (US)

(21) Appl. No.: 18/456,597

(22) Filed: Aug. 28, 2023

(51) Int. Cl. G06T 15/00

(52) U.S. Cl. CPC G06T 15/005

(57) ABSTRACT

Methods, systems, and non-transitory computer-readable media circumvent bottlenecking of graphics processing unit (GPU) parallelization during three-dimensional (3D) finite-difference time-domain (FDTD) simulation. Before running the 3D FDTD simulation, a central processing unit (CPU) creates 3D arrays and a mirror set of the 3D arrays, and stores the mirror set on a GPU. During runtime of the 3D FDTD simulation, the CPU sends, to the GPU, instructions to update arrays of interest of the mirror set on the GPU, which simultaneously updates array elements of 3D electromagnetic field components of each array in the arrays of interest. Upon completion of the 3D FDTD simulation, the CPU copies the updated arrays of interest from the GPU to the CPU by instructing the GPU to copy the updated arrays of interest from the GPU to corresponding mirror arrays pointed to on RAM, and writes the updated arrays of interest to an output file.

### TECHNICAL FIELD

This disclosure relates generally to finite-difference time-domain (FDTD) simulation, and more particularly to methods, systems, and computer-readable media for accelerating three-dimensional (3D) FDTD electromagnetic simulation using a mirrored graphics processing unit (GPU) domain.

### BACKGROUND

Finite-difference time-domain (FDTD) modeling is an increasingly important tool for modeling systems of materials interacting with electromagnetic wave phenomena at non-ionizing frequencies. FDTD modeling involves representing electromagnetic field components and material property tensor components as discretized three-dimensional (3D) arrays. Due to physical realities, it is necessary for these 3D arrays to be large in terms of memory. Methods for simulation of these FDTD models use a set of time-stepped update operations to update each time varying array during each time step using sequential central processing unit (CPU) techniques. While robust in utility and accuracy, these methods are operationally arduous.

Graphics processing units (GPUs), used for various processing-intensive applications, offer significant potential for simulation acceleration by performing the update operations for each array in parallel. However, the large size of the arrays representing the variables used in these update operations results in significant processing bottlenecks immediately before and after each update. These bottlenecks result in a processing slowdown greater than the time saved by performing the updates in parallel.

A solution is needed to realize the acceleration benefits of GPU parallelization while circumventing these bottlenecks. Such a solution can result in achieving exponential increases in speed in correlation with processing capacity of the GPU hardware utilized.

### BRIEF SUMMARY OF THE DISCLOSURE

In some embodiments, a method for circumventing bottlenecking of graphics processing unit (GPU) parallelization during three-dimensional (3D) finite-difference time-domain (FDTD) simulation is performed by a central processing unit (CPU) of a computer system and includes, before running the 3D FDTD simulation, creating a plurality of 3D arrays and a mirror set of the plurality of 3D arrays, and storing the mirror set on a GPU. Further, the method includes, during runtime of the 3D FDTD simulation, sending, from the CPU to the GPU, instructions to update arrays of interest of the mirror set on the GPU. The method also includes, upon completion of the 3D FDTD simulation, copying, by the CPU, the updated arrays of interest from the GPU to the CPU, and writing, by the CPU to an output file, the updated arrays of interest.

In some embodiments of the method, creating the plurality of 3D arrays includes creating a first 3D array by determining at least one of a plurality of grids; creating a first pointer to the first 3D array; allocating a first portion of random-access memory (RAM) of the computer system for the first 3D array; and storing, by the CPU in the RAM, the first 3D array in the first portion of the RAM identified by the first pointer.

In some embodiments of the method, creating the mirror set includes creating, by the CPU on the GPU, a second pointer to the first 3D array referred to by the first pointer and a first mirror 3D array pointed to by the second pointer; and copying, by the CPU to the GPU, data in the first 3D array pointed to by the first pointer to the first mirror 3D array pointed to by the second pointer.

In some embodiments of the method, copying the updated arrays of interest from the GPU to the CPU includes sending, by the CPU, an exit instruction to the GPU to copy the updated arrays of interest from the GPU to corresponding mirror arrays pointed to on the RAM.

In some embodiments of the method, the plurality of grids includes three-dimensional magnetic field grids and electric field grids. In some embodiments of the method, the plurality of grids further includes one or more of magnetic field sub-calculation grids, electric field sub-calculation grids, absorbing layer grids, Fourier transform grids, reflection and transmission sensor grids, displacement field grids, dispersion calculation grids, permittivity grids, and a material type grid for a materials system model.

Some embodiments of the method further include identifying, by the CPU, the arrays of interest including at least one array of the plurality of 3D arrays that is used in the 3D FDTD simulation, a quantity of arrays in the arrays of interest, and a quantity of elements in the arrays of interest.

In some embodiments of the method, the instructions to update the arrays of interest of the mirror set include communicating, by the CPU to the GPU, the quantity of arrays, the quantity of elements, and an instruction to update simulation data in the arrays of interest in any order according to operations of the 3D FDTD simulation, wherein updating the simulation data in the arrays of interest includes simultaneously updating array elements of each 3D electromagnetic field component of each array in the arrays of interest.

In some embodiments of the method, the updated simulation data on the GPU is copied to RAM of the computer system only upon the completion of the 3D FDTD simulation.

Further embodiments are described including a system for circumventing bottlenecking of GPU parallelization during 3D FDTD simulation, the system including a GPU, a CPU having one or more processors, and memory storing executable instructions that, when executed by the one or more processors, cause the system to perform steps of the method as described above.

Still further embodiments are described including a non-transitory computer-readable medium for circumventing bottlenecking of GPU parallelization during 3D FDTD simulation, the non-transitory computer-readable medium storing executable instructions, that, when executed by one or more processors of a computer system having a GPU and a CPU, cause the computer system to perform steps of the method as described above.

Various embodiments of the non-transitory computer-readable medium are described for acceleration of 3D FDTD simulations using GPU acceleration as applied to different industrial applications that can be similarly modeled for simulation. Various applications are described using aspects of the disclosed methods in different arrangements, as would be understood by a person having ordinary skill in the relevant art.

### BRIEF DESCRIPTION OF THE DRAWINGS

The accompanying drawings are incorporated herein and form a part of the specification, wherein:

FIG. 1A illustrates an example of a standard CPU computation method for 3D FDTD simulation;

FIG. 1B illustrates a graphical representation of an improved CPU computation method using GPU parallelization for accelerating 3D FDTD simulation, according to some embodiments;

FIG. 2 illustrates a CPU-GPU subsystem for which a mirrored GPU domain can be used for accelerating 3D FDTD electromagnetic simulation, according to some embodiments;

FIG. 3 illustrates a system implementation to create a mirror set of 3D arrays on a GPU for circumventing a bottleneck created by an implementation when copying updated 3D arrays from the GPU to a CPU in a 3D FDTD simulation, according to some embodiments;

FIG. 4 illustrates a flow chart of an example method for accelerating 3D FDTD electromagnetic simulation using a mirrored GPU domain, according to some embodiments;

FIG. 5 illustrates a flow chart of an example method for creating a plurality of 3D arrays and its mirror set, according to some embodiments;

FIG. 6 illustrates a flow chart of an example method for instructing a GPU to update arrays of interest of a mirror set of 3D arrays, according to some embodiments;

FIG. 7 illustrates a block diagram of a computer system for performing techniques described herein, according to some embodiments; and

FIG. 8 illustrates a comparison of a CPU and a GPU of the computer system as applicable to performing the techniques described herein.

In the drawings, like reference numbers generally indicate identical or similar elements. Additionally, the left-most digit(s) of a reference number generally identifies the drawing in which the reference number first appears.

### DETAILED DESCRIPTION OF THE EMBODIMENTS

The following description of particular embodiment(s) is set out to enable one to practice one or more implementations of this disclosure. The following description is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present disclosure. Those skilled in the art should also realize that such equivalent assemblies do not depart from the spirit and scope of the disclosure in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. Furthermore, the use of the terms a, an, etc. does not denote a limitation of quantity, but rather denotes the presence of at least one of the referenced items.

The use of the terms “first,” “second,” and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising,” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

### FDTD Implementation

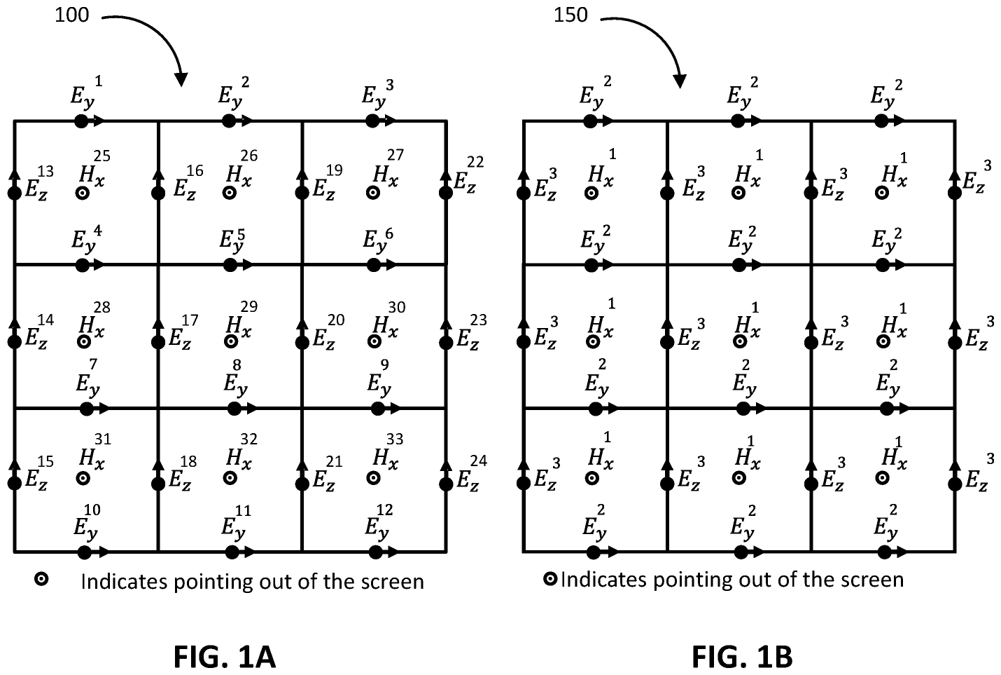

FIG. 1A illustrates a graphical representation 100 of a standard CPU computation method for 3D FDTD simulation. For example, in FDTD simulation for modeling systems of materials, a space having material properties ε and μ can be computer simulated as six interlocking 3D grids of Hₓ, H_{y}, H_{z}, Eₓ, E_{y}, and E_{z} electromagnetic fields. For example, Hₓ can be determined by:

$${H}_{x}^{t + Δ t} ( x ) = {H}_{x}^{t} ( x ) - \frac{Δ t}{μ Δ y} [ {E}_{z}^{t - \frac{Δ t}{2}} ( x + \frac{Δ x}{2} ) - {E}_{z}^{t - \frac{Δ t}{2}} ( x - \frac{Δ x}{2} ) ] - \frac{Δ t}{μ Δ z} [ {E}_{y}^{t - \frac{Δ t}{2}} ( x + \frac{Δ x}{2} ) - {E}_{y}^{t - \frac{Δ t}{2}} ( x - \frac{Δ x}{2} ) ] ,$$

where, to update the Hₓ component for the current time step, the E_{y} and E_{z} components on either side of the material grid (illustrated in FIG. 1A) from one time step earlier are determined.

Using standard CPU methods, the 3D FDTD simulation involves sequentially updating all Hₓ grid points (e.g., Hₓ points 1-9): the first, then the second, then the third, and so on. In three dimensions, the H_{y} 1-9 and H_{z} 1-9 grid points are similarly updated, followed by each of the grid points 1-12 for each of the Eₓ, E_{y}, and E_{z} fields, in a similar fashion. For example, as shown in FIG. 1A, each of the points E_{y} 1-12, E_{z} 13-24, and Hₓ 25-33 would be individually and serially updated.

In contrast, FIG. 1B illustrates a graphical representation 150 of an improved CPU computation method using GPU parallelization for accelerating 3D FDTD simulation, according to some embodiments. The improved method updates the discrete array elements of each electromagnetic field component Hₓ, H_{y}, H_{z}, Eₓ, E_{y}, and E_{z} simultaneously. For example, all the Hₓ grid points are updated at the same time using GPU parallelization. Then, the H_{y} and H_{z} grid points are similarly updated, followed by the grid points of the Eₓ, E_{y}, and E_{z} fields, in a similar fashion. This method reduces simulation runtime, because the grid points of each field component in the Nₓ×N_{y}×N_{z} grid can be updated without waiting for the other points to be updated.

Using GPU parallel computing in this way to vectorize data and compute sets of values all at once is known in the art. However, a known complication of using GPU hardware for such grid updates in, e.g., 3D FDTD simulation, is a bottleneck of interfacing with a CPU and its limitations, for example, to get data on and off the GPU device itself. A long-felt need exists to reduce this bottleneck and fully utilize the speed of a GPU.

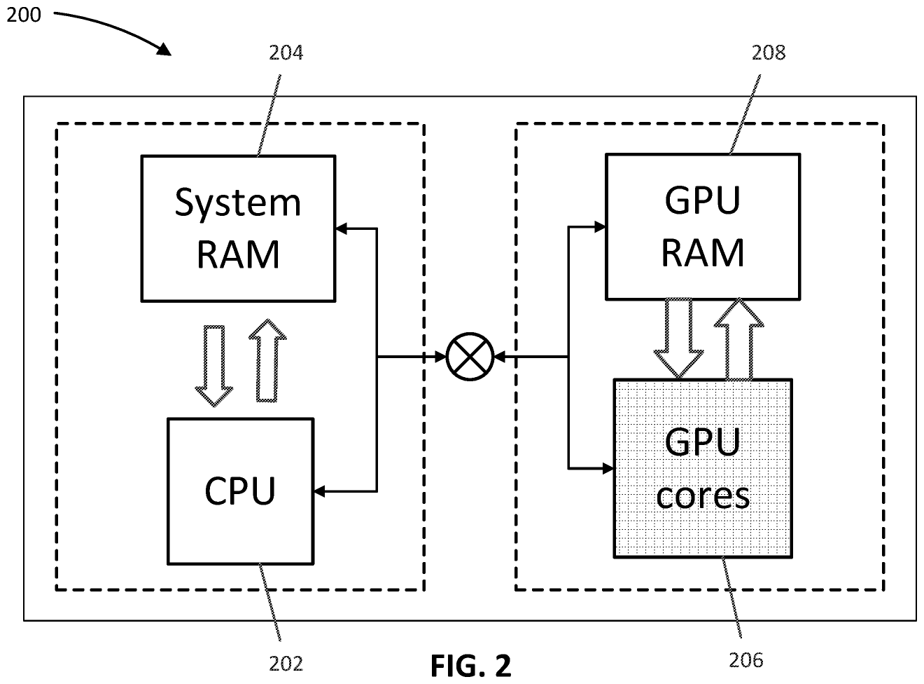

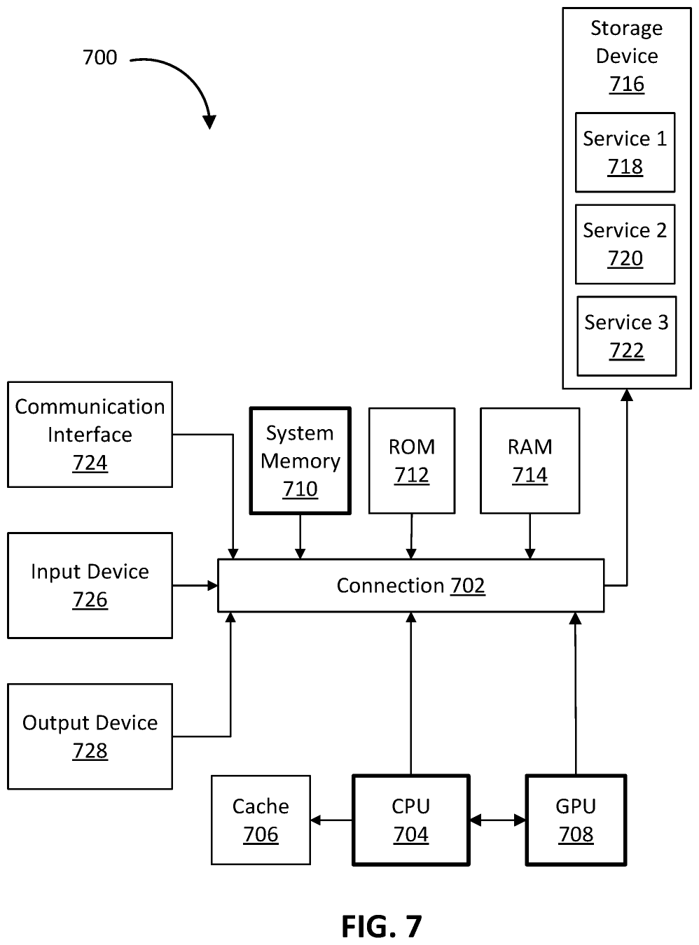

FIG. 2 illustrates a CPU-GPU subsystem 200 for which a mirrored GPU domain can be used for accelerating 3D FDTD electromagnetic simulation, according to some embodiments. As shown in FIG. 2, CPU 202 interfaces with system RAM 204 as traditionally understood by a person of ordinary skill in the art (for example, as in the computing system 700 of FIG. 7). As known in the art, GPU (having many processing cores) 206 is used to offload memory-intensive parallel processing operations from CPU 202. It is assumed that CPU-GPU subsystem 200 has sufficient GPU memory bandwidth with GPU RAM 208 for handling data from thousands of parallel processing tasks.

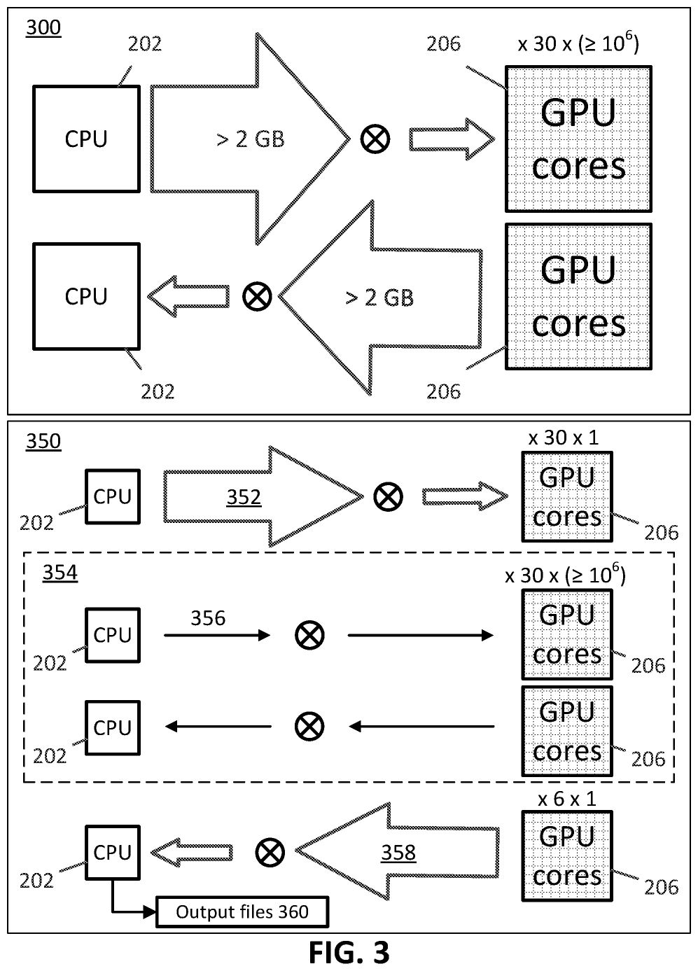

FIG. 3 illustrates an example (top box) of this bottlenecking between the CPU 202 and GPU 206 when using a standard CPU-GPU FDTD implementation 300. Traditionally, when GPU hardware is used as shown in FIG. 2 to process large data arrays (of the order of >2 gigabytes (GB)) seamlessly, the parallel array update of FIG. 1B is done at a speed much faster than a sequential CPU method. However, the bottleneck of getting data onto GPU 206 to do the update and off GPU 206 after the update is completed takes more time than is saved by employing the GPU parallelization method. This is because limited bandwidth over the CPU-GPU interface, e.g., a PCI Express (PCIe) interface, may significantly limit I/O operations per second (IOPS). Additionally, GPU 206 can compete with CPU 202 for relatively slow system RAM 204. During each of the >1 million time steps in a 3D FDTD simulation, a bottleneck can occur about 30 times.

Various approaches exist in the art to speed up an FDTD simulation, but each has limitations. Some of these approaches are specifically directed to accelerating FDTD for electromagnetics and electrodynamics, similar to the example embodiments disclosed herein. Although known methods may accelerate FDTD, they do not disclose improved GPU parallelization, nor specifically the method of GPU parallelization disclosed herein for accelerating 3D FDTD electromagnetic simulation for dispersive material, which requires a great deal more data for an accurate FDTD solution.

Such an FDTD solution for dispersive material operates on a grid of 200×200×1000 containing three magnetic field grids and three electric field grids (x, y, z), each containing 40 million points. To update each of these grids, 40 million calculations would be required each time step over 1 million time steps, requiring at least 240 trillion calculations. For dispersive materials having different permittivity at different wavelengths, an additional 3-24 grids of the same size are needed. Standard computing methods using an advanced CPU would require at least weeks to complete. Thus, GPU parallelization is needed for such a 3D FDTD solution.

U.S. Patent Application Publication No. 2015/0025869 A1, titled “System and Method of Implementing Finite Difference Time Domain Models with Multiple Accelerated Processing Components (APCS),” discloses speeding up an FDTD simulation method using GPUs and attempts to solve the same bottleneck. However, this publication discloses splitting up the physical space being simulated across different GPU devices but still transports data across the bottleneck each time step and does not disclose how the GPU parallelization is technically performed other than the split between multiple GPUs. This publication does not use a mirrored GPU domain as disclosed herein.

U.S. Patent Application Publication No. 2019/0324909 A1, titled “Information Processing Apparatus and Information Processing Method,” similar to the present disclosure, discloses using an FDTD simulation method for solving Maxwell's equations while attempting to overcome the same bottleneck. However, this disclosure attempts to maintain more memory in cache. Further, it restricts the GPU's instructions on which grid points to update and when, requiring more calculations per time step and more delays overall. This publication does not use a mirrored GPU domain as disclosed herein.

None of the known art uses mirror arrays as disclosed herein. Specifically, none of the art address how the many grids needed to simulate data-intensive FDTD problems, such as for dispersive materials, could be accelerated or could otherwise circumvent the bottleneck, without costly workarounds, such as splitting grids across multiple GPUs. This disclosure provides an improved GPU parallelization method that offers significant benefits over the art, improving the way a computer is used for 3D FDTD applications for circumventing a previously unsolved bottlenecking problem of getting simulation data on and off a GPU every time a new grid is updated in a data-intensive 3D FDTD simulation, and ultimately speeding up the simulation. This disclosure satisfies a long-felt need for improving data-intensive simulations, such as for modeling systems of dispersive materials, by fully utilizing GPU speed and reducing bottlenecking for a CPU-GPU FDTD simulation, but without using multiple GPUs. Specifically, the disclosed methods, systems, and computer-readable media accomplish an improvement to the CPU-GPU subsystem of FIG. 2 using a mirrored GPU domain, according to the described embodiments.

FIG. 3 further illustrates an example of a system implementation 350 (bottom box) having a mirror set of 3D arrays on GPU 206 that circumvents the bottleneck created by implementation 300 when copying updated 3D arrays from GPU 206 to CPU 202 in a 3D FDTD simulation, according to some embodiments. To circumvent the bottleneck, the CPU 202 creates 352 a mirror set of arrays on the GPU 206 for all 3D arrays at the beginning of the simulation, where each array of size, e.g., ×30×1, results in a mirror set of arrays of size, e.g., ×30×(≥106) on the GPU 206. During runtime of the simulation (hashed box 354), the CPU 202 only sends instructions 356 to the GPU 206 regarding which arrays to update and how (i.e., “arrays of interest”). In some embodiments, the CPU 202 can determine the arrays of interest by reading a user selection in “data copyout( )” instructions. For example, sensor arrays may be of interest and can be included in the data copyout( ) instructions.

At the end of the simulation, only the arrays of interest are copied 358 from the GPU 206's mirror arrays onto the CPU 202 to be written into output files 360. This improved process reduces the size of the communication between the CPU 202 and the GPU 206 by several orders of magnitude. The resulting benefit is a reduction in simulation runtime by multiple orders of magnitude.

### Exemplary Methods for 3D FDTD Electromagnetic Simulation

Flow charts representing example embodiments for methods 400, 500, and 600 for accelerating 3D FDTD electromagnetic simulation using a mirrored GPU domain are now described. As would be understood by a person of ordinary skill in the art, these methods can be implemented with various known computer languages and various frameworks for accelerated and parallel computing. Example embodiments disclosed herein can be implemented using the C computer language and the OpenAcc framework, for example. Methods described herein can be performed by a CPU of a computer system, interfacing with a GPU of the computer system, such as the computer system and its specific aspects illustrated in FIGS. 2, 3, 7, and 8.

The example embodiments described herein for methods 400, 500, and 600 perform 3D FDTD electromagnetic simulations for metamaterial devices. A metamaterial is a periodic (repeating) arrangement of materials that, when combined, have properties that the individual components do not have. The electromagnetic properties of a device having a two-dimensional metamaterial can be simulated by making the boundaries of the simulation periodic in the planar dimensions, where the left-most grid space is set adjacent to the right-most grid space (x dimension), and the top-most grid space is set adjacent to the bottom-most grid space (y dimension), and making the perpendicular boundaries in the simulation absorbing (z dimension).

For example, the metamaterial device for a 3D FDTD electromagnetic simulation can include a repeating pattern of gold crosses. In some embodiments, each gold cross can be layered below an “infinite” sheet of hexagonal boron-nitride (hBN) and layered above a SiO₂ spacer layer, a sheet of gold, and a silicon (Si) substrate that is infinite in the negative z direction, for example. In an example configuration of the 3D FDTD simulation system, the metamaterial device can be illuminated from above by unidirectional broadband source, for example. In the example system, infinite planar sensors above and below the metamaterial device can measure the reflection and transmission data of the simulated metamaterial, using a reflectance and transmittance sensor, respectively.

Various other configurations of the 3D FDTD simulation system can be used, the details of which would be understood by a person having ordinary skill in the art. The embodiments described herein can have various other industrial applications, some examples of which are described later in this disclosure. In such applications, as would be understood by a person having ordinary skill in the art, the methods, systems, and computer-readable media described herein can be used in different arrangements with similar material models specific to those of interest in the respective application.

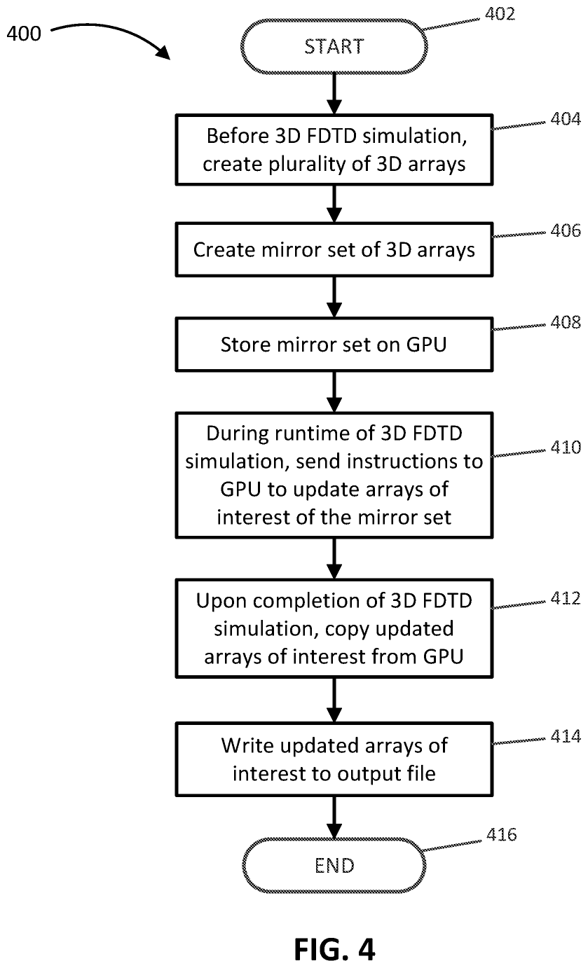

FIG. 4 illustrates a flow chart of an example method 400 for accelerating 3D FDTD electromagnetic simulation using a mirrored GPU domain, according to some embodiments. At the start 402 of method 400, sensors, a source input, and a grid for the simulation space is initialized such that memory is allocated for data arrays representing three-dimensional (3D) magnetic field grids and electric field grids. For example, these 3D field grids can include one or more of magnetic field sub-calculation grids, electric field sub-calculation grids, absorbing layer grids, Fourier transform grids, reflection and transmission sensor grids, displacement field grids, dispersion calculation grids, permittivity grids, and a material type grid for a materials system model, according to some embodiments.

The architecture for the simulation space is created by assigning each grid space an integer value representing a specific material, e.g., type 1 can be magnetized plasma, type 2 can be non-dispersive material, type 3 can be a Drude model metal, etc. The permittivity values for each material are then assigned to the corresponding permittivity grid. The location for the source input, reflectance sensor, and transmittance sensor are then defined. For the disclosed configuration, the initialization data is defined in C code. This initialization process would be understood by an ordinary person having skill in the relevant art so is not further described.

At step 404 of method 400, using the initialization data defined during the initialization process and before running the 3D FDTD simulation, the CPU 202 creates a plurality of 3D arrays and stores them in system memory, such as system RAM 204. The plurality of 3D arrays can include data defining a plurality of grids of a metamaterial model, where each 3D array can include one of a 3D magnetic field grid, a 3D electric field grid, a 3D magnetic field sub-calculation grid, a 3D electric field sub-calculation grid, a 3D absorbing layer grid, a 3D Fourier transform grid, a 3D reflection sensor grid, a 3D transmission sensor grid, a 3D displacement field grid, a 3D dispersion calculation grid, a 3D permittivity grid, and a 3D material type grid for a materials system model, for example.

At step 406 of method 400, to circumvent data transfer bottlenecking, the CPU 202 creates mirror arrays of the plurality of 3D arrays. At step 408, a mirror set, including the mirror arrays of the plurality of 3D arrays, is then stored on the GPU memory, such as GPU RAM 208, of GPU 206. It is noted that the initial array values assigned during grid initialization are loaded onto the GPU 206 only once. CPU 202 then creates and assigns pointers to the data in the 3D arrays to later instruct GPU 206 which of the mirrored 3D arrays in GPU RAM 208 correspond to the 3D arrays stored in system RAM 204. Creation of such pointers is further defined in the description of method 500.

At step 410, during runtime of the 3D FDTD simulation, to determine updates to the various 3D field grids, the CPU 202 sends, to the GPU 206, instructions to update arrays of interest of the mirror set on the GPU RAM 208. Step 410 is performed in a time loop. For example, for every time t, CPU 202 updates the various 3D field grids. Specifically, the curl of the electric field grid can be determined, e.g., as ∇×E(x, y, z). The electric field portion of the directional signal can then be added to the electric field curl at a designated layer. A new magnetic field grid can be determined, e.g., as H_{new}(x, y, z)=H_{old}(x, y, z)+(Δtc₀)∇×E(x, y, z). An absorbing layer can then be implemented for the magnetic field grid. The curl of the magnetic field grid can then be determined, e.g., as ∇×H(x, y, z). The magnetic field portion of the directional signal can then be added to the electric field curl at a designated later. A new displacement field grid can then be determined, e.g., as D_{new}(x, y, z)=D_{old}(x, y, z)+(Δtc₀)∇×H(x, y, z). The absorbing layer can then be implemented for the displacement field grid. A new electric field grid (e.g., E(x, y, z)) can then be determined, e.g., as a product of the new displacement field grid (e.g., D(x, y, z)) and a 3D tensor of the material properties εₓ, ε_{xy}, ε_{xz}, ε_{yx}, ε_{yy}, ε_{yz}, ε_{zx}, ε_{zy}, ε_{zz}, for example. The frequency domain reflectance and transmittance sensor values can then be updated. From the updated data points, a two-dimensional animation can then be recorded at a frequency chosen by the user, according to some embodiments.

A time loop is repeated during the 3D FDTD simulation for each of the various 3D field grids until the 3D simulation data are determined and stored to updated arrays, for example: all x, y, and z components of the curl of the electric field grid, including at periodic boundaries in the x and y directions to the edges and corners of the grid; all x, y, and z components of the magnetic field grid; all damping values for the magnetic field within both absorbing and bottom boundaries; all x, y, and z components of the curl of the magnetic field grid; all x, y, and z components of the displacement field grid; and all damping values for the electric field within both absorbing and bottom boundaries. Additional simulation data may be determined and stored, as would be understood by person having ordinary skill in the art.

At step 412, upon completion of the 3D FDTD simulation (e.g., when all arrays are updated), CPU 202 then copies the updated arrays of interest from the GPU 206 to the CPU 202. In some embodiments, the desired simulation data on the GPU 206 may be copied to system RAM 204 only upon the completion of the 3D FDTD simulation. In some embodiments, to initiate this copying, CPU 202 may send an exit instruction to GPU 206 to copy the updated arrays of interest from GPU 206 to corresponding mirror arrays pointed to on system RAM 204. At step 414, the CPU 202 writes the updated arrays of interest to an output file for further user analysis at the end 416 of the process.

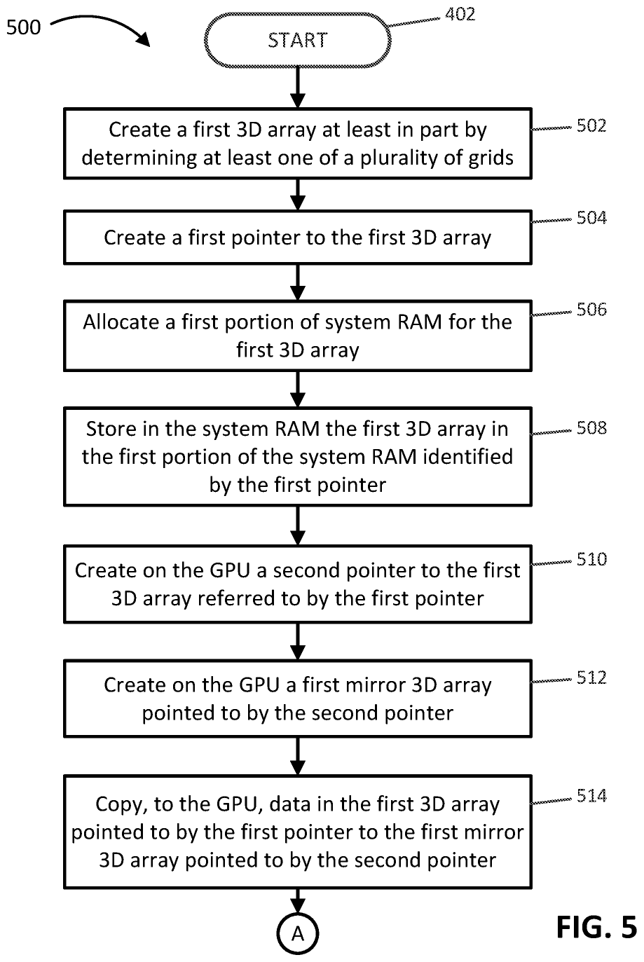

FIG. 5 illustrates a flow chart of an example method 500 for creating a plurality of 3D arrays and its mirror set, according to some embodiments. Method 500 performs substeps for step 404 (steps 502-508 for creating 3D arrays of grid data) and step 406 (steps 510-514 for creating a mirror set of the 3D arrays) of method 400.

In step 502 of method 500, the CPU 202 creates a first 3D array at least in part by determining at least one of a plurality of grids of a metamaterial model, for example. The plurality of grids can include 3D magnetic field grids, electric field grids, magnetic field sub-calculation grids, electric field sub-calculation grids, absorbing layer grids, Fourier transform grids, reflection and transmission sensor grids, displacement field grids, dispersion calculation grids, permittivity grids, and a material type grid for a materials system model, for example.

In step 504, the CPU 202 creates a first pointer to the first 3D array. Creating a pointer would be understood by a person of ordinary skill in the computing arts and is thus not further described here. In step 506, the CPU 202 allocates a first portion of system RAM 204 for the first 3D array. Allocating portions of system RAM would be understood by a person of ordinary skill in the computing arts and is thus not further described here. In step 508, the CPU 202 stores the first 3D array in the first portion of the system RAM 204 identified by the first pointer in the system RAM 204. Steps 502 through 508 are repeated for each of the 3D arrays of a metamaterial model until the model is defined.

To create the mirror set of the 3D arrays, in step 510, CPU 202 creates a second pointer to the first 3D array referred to by the first pointer in system RAM 204. Next, in step 512, CPU 202 creates a first mirror 3D array pointed to by the second pointer to be stored on the GPU 206 in GPU RAM 208. In step 514, CPU 202 then copies, to GPU RAM 208, data in the first 3D array pointed to by the first pointer to the first mirror 3D array pointed to by the second pointer.

Steps 510 through 514 are repeated for each of the 3D arrays of the metamaterial model until a mirror set of all 3D arrays are created. Once all 3D arrays and their mirror arrays are created, the runtime process for the 3D FDTD simulation can begin at point A of method 500.

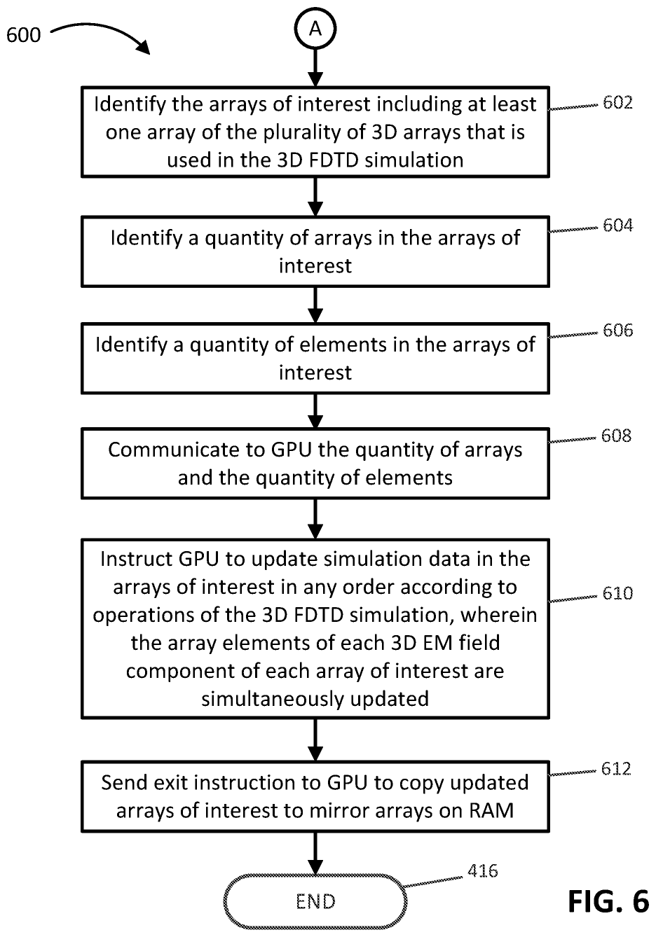

FIG. 6 illustrates a flow chart of an example method 600 for instructing GPU 206 to update arrays of interest of the mirror set of 3D arrays, according to some embodiments. Method 600 further defines step 410 of method 400, according to some embodiments.

In preferred embodiments, instructions from CPU 202 to GPU 206 to update arrays of interest in the mirror set are sent as #pragma statements in C code. Using such #pragma statements, the data of interest completes a single round trip, onto GPU 206 from system RAM 204 before the 3D FDTD simulation, and off of GPU 206 to system RAM 204 once the simulation has completed. Thus, CPU 202 never directly interacts with the grid data between these two points. Between these two points, CPU 202 uses the aforementioned pointers (see, e.g., method 500) to direct GPU 206 to use specific 3D arrays of grid data (arrays of interest) for making updates to the 3D arrays. Such instructions from CPU 202 are significantly smaller in memory than the 3D arrays to which they refer. Thus, these instructions can be transmitted to and from GPU 206 without encountering a bottleneck. Additionally, if a given 3D array is needed for further updates by GPU 206, the updated 3D array is always present on GPU RAM 208 until the completion of the simulation. Further, because all updates to the 3D arrays are performed by GPU 206 directly, and never CPU 202, the processing workload will not fall on CPU 202, which has significantly fewer cores to handle the increased processing load of such data-intensive 3D FDTD simulations as described herein.

In step 602 of method 600, CPU 202 identifies the arrays of interest comprising at least one array of the plurality of 3D arrays that is used in the 3D FDTD simulation. In some embodiments, the arrays of interest are any arrays desired by and selected by the user for analysis, e.g., arrays including the reflection or transmission sensor data or two-dimensional (2D) movie data. However, any of the simulation arrays could be of interest to a user. Recording and analyzing only arrays of interest from the simulation conserves memory and run time by only copying and recording desired data, which could be a subset of the available plurality of 3D arrays. The plurality of 3D arrays can include magnetic field grids and electric field grids. For example, these 3D field grids can include one or more of magnetic field sub-calculation grids, electric field sub-calculation grids, absorbing layer grids, Fourier transform grids, reflection and transmission sensor grids, displacement field grids, dispersion calculation grids, permittivity grids, and a material type grid for a materials system model, according to some embodiments.

In step 604, CPU 202 identifies a quantity of arrays in the arrays of interest. In step 606, CPU 202 identifies a quantity of elements in the arrays of interest. Then, in step 608, CPU 202 communicates to GPU 206 the quantity of arrays and the quantity of elements. In step 610, CPU 202 then sends an instruction to GPU 206 to update simulation data in the arrays of interest in any order according to operations of the 3D FDTD simulation. Further, updating the simulation data in the arrays of interest includes GPU 206 simultaneously updating array elements of each 3D electromagnetic field component of each array in the arrays of interest, for example, by way of parallel processing by GPU 206's multiple cores.

Specifically, CPU 202 determines the curl of the electric field grid for every point within the simulation space, which includes the metamaterial being simulated, and a space above the device, and/or a continuous substrate below the device, according to some embodiments. First, CPU 202 redefines in scope (i.e., within the present C code function) the pointers to the relevant mirror arrays on GPU RAM 208 for instructing the GPU 206 to operate on a specific memory location in GPU RAM 208. Then, CPU 202 instructs GPU 206 which arrays are needed to update the x component of the curl of the electric field grid, and further instructs GPU 206 to update the grid components in any order. Updates are performed for each time step. To create periodic boundaries in the x and y directions, additional updates are performed by GPU 206 at the edges and corners of the grid. Specifically, at a periodic boundary, GPU 206 treats the first and last element in a given dimension as adjacent, e.g., E(i.j,N_{z}+1)=E(i,j,0), where N_{z} is the number of elements in the array in the z dimension and i and j are arbitrary integers. This part of the process is repeated to determine the y and z components of the curl of the electric field grid.

CPU 202 updates the electric field component of the source input signal at the current time step using a time-dependent broadband function, according to some embodiments. CPU 202 redefines in scope the pointers to the relevant mirror arrays on GPU RAM 208. CPU 202 then determines the time dependent signal for the current time step. CPU 202 instructs GPU 206 which arrays are needed to determine the x component of the curl of the electric field grid, and further instructs GPU 206 to update the grid components in any order.

Then, to update the magnetic field grid of the simulation space, CPU 202 redefines in scope the pointers to the relevant mirror arrays on GPU RAM 208. CPU 202 instructs GPU 206 which arrays are needed to update the x component of the magnetic field grid, and further instructs GPU 206 to update the grid components in any order. This part of the process is repeated to update the y and z components of the magnetic field grid.

CPU 202 next implements the magnetic field absorbing layer of the simulation space, according to some embodiments. CPU 202 redefines in scope the pointers to the relevant mirror arrays on GPU RAM 208. CPU 202 instructs GPU 206 which arrays are needed to determine damping coefficients for the magnetic field grid in the top absorbing layer of the metamaterial, and further instructs GPU 206 to update the grid components in any order. The damping coefficients are added to the magnetic field within the absorbing boundary. This part of the process is then repeated on the bottom boundary of the metamaterial.

To determine the curl of the magnetic field grid of the simulation space, CPU 202 redefines in scope the pointers to the relevant mirror arrays on GPU RAM 208. Then, CPU 202 instructs GPU 206 which arrays are needed to update the x component of the curl of the magnetic field grid, and further instructs GPU 206 to update the grid components in any order. To create periodic boundaries in the x and y directions, additional updates are performed by GPU 206 at the edges and corners of the grid to explicitly set the first and last components in a given dimension as adjacent. This part of the process is repeated to update the y and z components of the curl of the magnetic field grid.

CPU 202 determines the magnetic field component of the source input signal at the current time step using a time-dependent broadband function, according to some embodiments. CPU 202 redefines in scope the pointers to the relevant mirror arrays on GPU RAM 208. CPU 202 then determines the time dependent signal for the current time step. CPU 202 instructs GPU 206 which arrays are needed to update the x component of the curl of the magnetic field grid, and further instructs GPU 206 to update the grid components in any order.

CPU 202 next updates the displacement field grid of the simulation space, according to some embodiments. To update the displacement field grid, CPU 202 redefines in scope the pointers to the relevant mirror arrays on GPU RAM 208. CPU 202 instructs GPU 206 which arrays are needed to update the x component of the displacement field grid, and further instructs GPU 206 to update the grid components in any order. This part of the process is repeated to determine the y and z components of the displacement field grid.

CPU 202 next implements the electric field absorbing layer of the simulation space, according to some embodiments. CPU 202 redefines in scope the pointers to the relevant mirror arrays on GPU RAM 208. CPU 202 instructs GPU 206 which arrays are needed to determine damping coefficients for the electric field grid in the top absorbing layer of the metamaterial, and further instructs GPU 206 to update the grid components in any order. The damping coefficients are added to the electric field within the absorbing boundary. This part of the process is then repeated on the bottom boundary of the metamaterial.

Next, to update the electric field grid of the simulation space, CPU 202 determines material-model specific arrays to update the x component of the displacement field grid. CPU 202 calculates variables for the frequency domain material model by running the 3D FDTD simulation to solve for a set of material, or auxiliary differential equations (ADE), according to some embodiments.

The relationship between the displacement field and the electric field for a dispersive material is a function of the frequency domain. To implement this relationship in FDTD, it must first be transformed to the time domain. The resulting transformation is unique to the material model being converted (e.g., Drude model, Lorentz model, Debye model). For a given material these models may be the same in all directions (diagonally isotropic), different in different directions (diagonally anisotropic), or influenced by orthogonal field values (diagonally anisotropic). When each material model is transformed into the time domain, each term resulting from the transform requires a 3D array that is updated using an ADE that is a function of the electric field from both the current and the previous time step.

Specifically, CPU 202 instructs GPU 206 which arrays are needed to update the x component of the electric field. CPU 202 then instructs GPU 206 which arrays are needed to update the ADE arrays. The number of ADE arrays required for the x component of the electric field is between 0 and 7, depending on the material model. In some embodiments, these ADE update arrays and equations may be different in the y and z components of the electric field from the x component.

CPU 202 redefines in scope the pointers to the relevant mirror arrays on GPU RAM 208. CPU 202 then instructs GPU 206 which arrays are needed to update the x component of the electric field grid and any x component electric field point sensors, and further instructs GPU 206 to update the grid components in any order. This process is repeated to determine the y and z components of the electric field grid and their respective point sources.

To further update the electric field grid of the simulation space, CPU 202 instructs GPU 206 which arrays are needed to update all components of the ADE grids for each material model, and further instructs GPU 206 to update the grid components in any order. This process is repeated for each frequency domain material model.

Where necessary, the ADE grid values for the last two time steps are saved. Where necessary, the electric field grid values for the last time steps are saved. For example, according to some embodiments, some material models may require higher order frequency terms (e.g., omega is first order, omega squared is second order, theoretically omega cubed is third order, etc.). Due to the transform (e.g., conversion) from the frequency domain to the time domain, every frequency term will result in an ADE that requires the knowledge of the electric field at that point in space as many time steps earlier in time as the order of the frequency term. For example, a first order frequency term will produce an ADE that needs the electric field at that point in space one time step earlier than a second order term needs to know the electric field two time steps earlier. To calculate the ADEs in subsequent time steps, the electric field at that time step is recorded in its own 3D array.

CPU 202 then updates the planar sensors. CPU 202 redefines in scope the pointers to the relevant mirror arrays on GPU RAM 208. CPU 202 then instructs GPU 206 which arrays are needed to update all components of the reflectance and transmittance sensors. The sensors are updated by determining the current value of the discrete Fourier transform for every grid point along the plane of each sensor. CPU 202 further instructs GPU 206 to update the grid components in any order.

CPU 202 then initiates the recording of an animation frame at intervals determined via user input over a user interface, for example, on input device 726. CPU 202 redefines in scope the pointers to the relevant mirror arrays on GPU RAM 208. CPU 202 then instructs GPU 206 which arrays are needed to record the current animation frame in the xy plane, and further instructs GPU 206 to record the elements of the animation frame in any order. This process is repeated over the selected intervals for the xy plane.

After all updates and recording of the data of interest, CPU 202 outputs the sensor data for further user analysis, as disclosed for steps 412 and 414 of method 400. CPU 202 redefines in scope the pointers to the mirror arrays on GPU RAM 208 that are to be output. The data from the relevant mirror arrays are then copied from GPU 206 onto their associated mundane arrays on system RAM 204. This data of interest is then output and saved to a data file for further analysis, as would be understood by a person of ordinary skill in the art. This process is repeated for all data of interest.

In some embodiments, the updated simulation data (i.e., the updated arrays of interest) on the GPU 206 may be copied to system RAM 204 only upon the completion of the 3D FDTD simulation disclosed above. In some embodiments, to initiate this copying, CPU 202 may, in step 612, send an exit instruction to GPU 206 to copy the updated arrays of interest from GPU 206 to corresponding mirror arrays pointed to on system RAM 204 to end 316 the process.

FIG. 7 illustrates a block diagram of a computing system 700 for performing techniques described herein, according to some embodiments. Computing system 700 can be, for example, any computing device for implementing aspects of the system 200 for accelerating 3D FDTD electromagnetic simulation, or any component thereof in which the components of the computing system 700 are in communication with each other using connection 702. Connection 702 can be a physical connection, such as via a bus, or a direction connection into one or more processors of CPU 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc., and alternatively, or additionally, by aspects of a cloud computing system. In some embodiments, one or more of the described system components of computing system 700 can represent many such components, each performing some or all of the functions for which the component is described. In some embodiments, the components of computing system 700 can be physical or virtual devices, or a combination thereof.

Computing system 700 can include at least one processing unit, such as central processing unit (CPU) 704 and graphics processing unit (GPU) 708, each including one or more processors, coupled, by connection 702, to various computing system components including system memory 710, read-only memory (ROM) 712, and/or random-access memory (RAM) 714. Computing system 700 can also include a high-speed memory cache 706 connected directly with, in close proximity to, or integrated with CPU 704, for example. With reference to the CPU-GPU subsystem illustrated in FIG. 2, CPU 704 can be CPU 202; GPU 708 can be GPU 206 with GPU RAM 208; and RAM 714 can be system RAM 204, for example.

CPU 704 can include any general-purpose processor(s) and one or more hardware or software service(s), such as services 718, 720, 722 stored in storage device 716, configured to control the one or more processors of CPU 704. A software service can perform one or more functions when the one or more processors execute(s) the software associated with the service. In some embodiments, a service is a program or a collection of programs that carry out a specific function. In some embodiments, a service can be considered a server. CPU 704 can alternatively, or additionally, include a special-purpose processor having software instructions incorporated into the processor design.

CPU 704 may be a completely self-contained computing system containing multiple cores as the one or more processors, a bus, a memory controller, cache, etc. A multi-core processor may be symmetric or asymmetric. For example, CPU 704 can be implemented as one or more microprocessors, microcomputers, microcontrollers, digital signal processors, central processing units, state machines, logic circuits, and/or any devices that manipulate signals based on operational instructions. In some examples, CPU 704 can be one or more hardware processors and/or logic circuits of any suitable type specifically programmed or configured to execute the operations and processes described herein. CPU 704 can be configured to execute computer-readable and processor-executable instructions stored in non-transitory computer-readable media.

Non-transitory computer-readable media can be used to store and maintain any number of functional components that are executable by the one or more processors of CPU 704. In some embodiments, these functional components include instructions or programs that are executable by the one or more processors of CPU 704, and that, when executed, implement operational logic for performing the processes and services described herein by computing system 700, implementing system 200, for example.

Non-transitory computer-readable media can also optionally include other functional components and data, which can include programs, drivers, etc., and the data used or generated by the functional component, such as any elements described herein as used by the system 200 and the computing system 700. In addition, the non-transitory computer-readable media can store data, data structures, and the like, which can be used by the functional components. The non-transitory computer-readable media can include additional functional components, such as an operating system for controlling and managing various functions of and enabling user interactions with system 200 and for controlling and managing various server and cloud server functions, as applicable.

GPU 708 is a specialized microprocessor chip serving as a co-processor for heavy processing tasks requiring highly parallel independent calculations (also known as “embarrassingly parallel tasks”), such as the 3D FDTD simulation operations disclosed herein. These processing intensive operations can be offloaded from CPU 704 to GPU 708 to accelerate memory-intensive calculations that may otherwise bottleneck the CPU's processing. While CPU 704 has a few processing cores and relatively more cache memory for simultaneously handling software threads using sequential serial processing, GPU 708 can have a wide vector width single-instruction, multiple-data (SIMD) architecture with thousands of smaller processing cores that can simultaneously handle multiple software threads in parallel. With its many multiple cores, GPU 708 can process a set of vectorized data all at once.

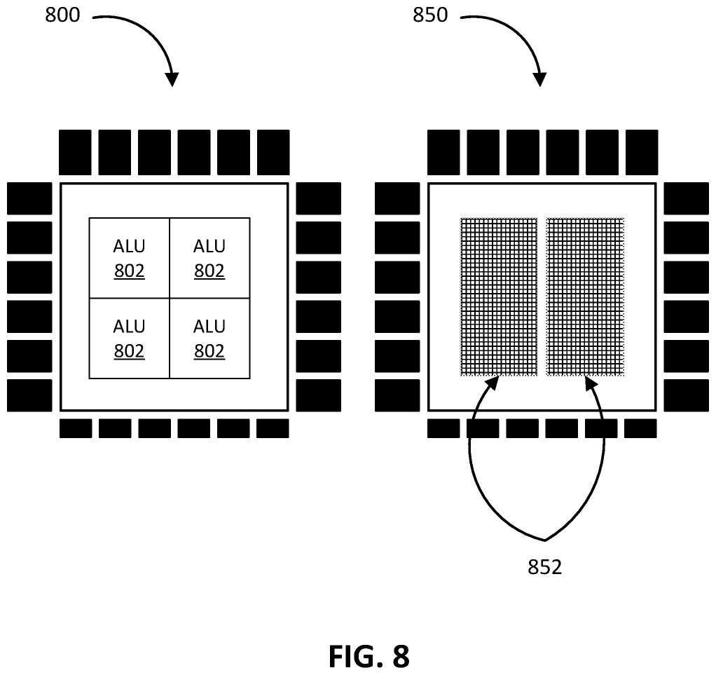

A general comparison of the CPU versus GPU architecture is illustrated in FIG. 8. FIG. 8 illustrates a comparison of a CPU and a GPU using simplified examples CPU 800 and GPU 850, according to some embodiments. For comparison purposes, CPU 800 represents CPU 704 and GPU 850 represents GPU 708. CPU 800 includes fewer execution units, also called arithmetic logic units (ALUs) 802, that are optimized for serial operations with lower compute densities. GPU 850 includes many parallel execution units (or, ALUs 852) for parallel operations with higher compute densities.

The interface between CPU 704 and GPU 708 can be a PCIe interface, an Accelerated Graphics Port (AGP), or similar interface as understood by a person having ordinary skill in the art. GPU 708 can support application programming interface (API) extensions to the C programming language, such as OpenCL, OpenMP, and OpenACC frameworks, for example, and other vendor-specific APIs. Compute kernels running on GPU 708 can allow C programs to leverage the GPU's ability to operate on large buffers in parallel, while still using CPU 704 when appropriate. Thus, CPU-based applications can directly access the resources of GPU 708 for various intensive computing tasks.

Storage device 716 can be a non-volatile memory device, a hard disk, or other type of non-transitory computer-readable media that can store data that are accessible by a computer, such as magnetic cassettes, flash memory cards, solid state memory devices, digital versatile disks, cartridges, random-access memories (RAMs), read-only memory (ROM), and/or some combination of these devices. Storage device 716 can include software services, servers, programs, etc., such that when code that defines such services, servers, or programs is executed by the one or more processors of CPU 704, execution of the code causes the system to perform one or more functions. In some embodiments, a hardware service that performs a particular function can include the software component stored in a non-transitory computer-readable medium in connection with the necessary hardware components, such as CPU 704, connection 702, output device 728, etc., to carry out the function.

Computing system 700 can include communication interface 724, which can govern and manage user input and system output. The communication interface 724 can include one or more interfaces and hardware components for enabling communication with various other devices, such as over one or more networks. The one or more networks can include, but are not limited to, any type of network known in the art, such as a local area network or a wide area network (such as the Internet), and can include a wireless network (such as a cellular network), a cloud network (such as a cloud computing system), a local wireless network (such as Wi-Fi and/or close-range wireless communications, such as Bluetooth®, BLE, NFC, RFID), a wired network, or any other such network, e.g., a fiber optic network, or any combination thereof. Components used for such communication interface 724 can depend at least in part on the type of network, the environment selected, or both. Protocols for communicating over such networks are known to a person of ordinary skill in the art and need not be discussed in detail herein.

Computing system 700 can include an input device 726 for user interaction. Input device 726 can include one or more input mechanisms known to those of skill in the art, such input mechanisms including a microphone for speech, a touch screen for gesture or graphical input, a keyboard, a mouse, motion input, etc. Computing system 700 can also include output device 728, which can include one or more output mechanisms known to those of skill in the art. In some embodiments, multimodal systems can enable a user to provide multiple types of input/output to communicate with computing system 700.

Features of computing system 700 may be substituted for improved hardware or firmware arrangements or configurations as they are developed. In various embodiments, the present technology, including any of the steps, operations, functions, or processes, may be represented by individual functional blocks including hardware devices, hardware device components, software or services embodying method steps or routines, or combinations of such hardware and software.

Methods 400, 500, and 600 described herein can be implemented using computer-executable instructions that are stored or otherwise available from the non-transitory computer-readable media described herein. Such instructions can include, for example, instructions and data that cause or configure a general-purpose computer, special-purpose computer, or special-purpose processing device to perform a certain function or group of functions. Portions of computer resources used can be accessible over a network. The computer-executable instructions may be binaries, intermediate format instructions such as assembly language, firmware, or source code, for example. Examples of computer-readable media that may be used to store instructions, information used, and/or information created during processes include magnetic or optical disks, solid-state memory devices, flash memory, USB devices provided with non-volatile memory, networked storage devices, etc. Computer-readable storage devices, media, and memories can include a cable or wireless signal containing a bit stream. Non-transitory computer-readable media disclosed herein expressly exclude media such as energy, carrier signals, electromagnetic waves, and signals per se.

Devices implementing methods disclosed herein can include hardware, firmware, and/or software, and can take any of a variety of form factors, including servers, laptops, smartphones, personal computers, personal digital assistants, etc. Functions described herein can also be implemented in peripherals, in add-in cards, and/or on a circuit board, which can include various chips and processes executing in a single device, for example.

### Other Embodiments and Applications

Various other embodiments as well as certain variations and modifications of the embodiments described herein will occur to those skilled in the art upon becoming familiar with the underlying concept. It should be understood, therefore, that aspects of this disclosure may be practiced other than as specifically set forth herein.

For example, aspects of this disclosure for 3D FDTD simulation using a mirrored GPU domain may be applied for tuning metamaterial parameters. By varying the dimensional parameters of a metamaterial structure, the resulting properties can be tuned to those desired for a given application. Such properties would be significantly more expensive and time consuming to determine via experimental methods.

As another example, aspects of this disclosure for 3D FDTD simulation using a mirrored GPU domain may be applied for far-field analysis of photonic structures. The increased processing speeds realized by the aspects of this disclosure enable types of visualizations requiring higher resolution, such as behavioral trends of plasmons, phonons, and polaritons, that would be impractical with legacy plotting methods.

Further, aspects of this disclosure for 3D FDTD simulation using a mirrored GPU domain may be used for studying near-field plasmonic properties. For example, a spectral sensor could be placed at the surface or perpendicular to the surface of a device to study near-field plasmonic devices capable of exceeding diffraction limits.

Additionally, aspects of this disclosure for 3D FDTD simulation using a mirrored GPU domain may be used for designing circuit board shielding. If individual components of a circuit board are of known permittivity, a material model can be constructed in a simulation space. Using a broadband microwave frequency source and a planar reflectance and transmittance sensor, the absorptance can be determined, which could inform a circuit board designer which frequencies could potentially damage the circuit board. Once the hazardous frequencies are determined, various material arrangements can be trialed to determine a potential shielding solution. This process would enable the testing of several material arrangements without requiring destruction of valuable circuit boards.

Still further, aspects of this disclosure for 3D FDTD simulation using a mirrored GPU domain may be used for simulating radar spoofing materials. This could be done by placing an object in the simulation space whose surface permittivity properties in a radar frequency band are known. Then, a source transmitting a broadband radar frequency could be placed in front of a planar reflectance sensor. If the reflectance sensor does not record a reflected signal beyond background noise, the surface can be considered a potential candidate for radar spoofing material. This application would be useful for stealth purposes.

Aspects of this disclosure for 3D FDTD simulation using a mirrored GPU domain could also be used to create photonic band diagrams in FDTD. In this application, an object of non-vacuum permittivity could be placed in the center of the simulation space. Bloch periodic boundaries could be placed on the edges of the simulation space, allowing only modes with a wave vector to propagate. Then, several broadband sources could be placed at arbitrary positions in the simulation space. Several detectors could be placed at other arbitrary positions. The electric field strength as a function of time could be recorded during the entire simulation run, and the sum of the Fourier transform for all time series data could be used to determine the power spectral density (PSD) of the system. The simulation could be repeated with Bloch periodic boundary conditions. By plotting the frequency of the PSD peaks as a function of the Bloch boundary vectors, the frequencies that propagate in a structure can be determined. For example, available propagation bands in a multimodal optical fiber could be determined.

No limitation of the appended claims should be implied based on particular features or arrangements in the examples of this disclosure, as one of ordinary skill would be able to use these examples to derive a wide variety of implementations. It is also to be understood that the subject matter defined in the appended claims is not limited to the described features, as the features can be arranged differently or performed in components other than those identified herein. Rather, the described features are disclosed as examples of components, methods, systems, and computer-readable media within the scope of the appended claims.

What is claimed is:

1. A method for circumventing bottlenecking of graphics processing unit (GPU) parallelization during three-dimensional (3D) finite-difference time-domain (FDTD) simulation, the method performed by a central processing unit (CPU) of a computer system and comprising:
before running the 3D FDTD simulation:
creating, by the CPU, a plurality of 3D arrays;
creating, by the CPU, a mirror set of the plurality of 3D arrays; and
storing, by the CPU, the mirror set on a GPU;
during runtime of the 3D FDTD simulation:
sending, from the CPU to the GPU, instructions to update arrays of interest of the mirror set on the GPU; and
upon completion of the 3D FDTD simulation:
copying, by the CPU, the updated arrays of interest from the GPU to the CPU; and
writing, by the CPU to an output file, the updated arrays of interest.

2. The method of claim 1, wherein creating the plurality of 3D arrays comprises:
creating, by the CPU, a first 3D array, wherein creating the first 3D array comprises determining at least one of a plurality of grids;
creating, by the CPU, a first pointer to the first 3D array;
allocating, by the CPU, a first portion of random-access memory (RAM) of the computer system for the first 3D array; and
storing, by the CPU in the RAM, the first 3D array in the first portion of the RAM identified by the first pointer.

3. The method of claim 2, wherein creating the mirror set comprises:
creating, by the CPU on the GPU, a second pointer to the first 3D array referred to by the first pointer;
creating, by the CPU on the GPU, a first mirror 3D array pointed to by the second pointer; and
copying, by the CPU to the GPU, data in the first 3D array pointed to by the first pointer to the first mirror 3D array pointed to by the second pointer.

4. The method of claim 1, further comprising:
identifying, by the CPU, the arrays of interest comprising at least one array of the plurality of 3D arrays that is used in the 3D FDTD simulation;
identifying, by the CPU, a quantity of arrays in the arrays of interest; and
identifying, by the CPU, a quantity of elements in the arrays of interest.

5. The method of claim 4, wherein the instructions to update the arrays of interest of the mirror set comprise:
communicating, by the CPU to the GPU, the quantity of arrays, the quantity of elements, and an instruction to update simulation data in the arrays of interest in any order according to operations of the 3D FDTD simulation,
wherein updating the simulation data in the arrays of interest comprises simultaneously updating array elements of each 3D electromagnetic field component of each array in the arrays of interest.

6. The method of claim 5, wherein the updated simulation data on the GPU is copied to RAM of the computer system only upon the completion of the 3D FDTD simulation.

7. The method of claim 2, wherein copying the updated arrays of interest from the GPU to the CPU comprises:
sending, by the CPU, an exit instruction to the GPU to copy the updated arrays of interest from the GPU to corresponding mirror arrays pointed to on the RAM.

8. The method of claim 2, wherein the plurality of grids comprise three-dimensional magnetic field grids and electric field grids.

9. The method of claim 8, wherein the plurality of grids further comprise one or more of magnetic field sub-calculation grids, electric field sub-calculation grids, absorbing layer grids, Fourier transform grids, reflection and transmission sensor grids, displacement field grids, dispersion calculation grids, permittivity grids, and a material type grid for a materials system model.

10. A system for circumventing bottlenecking of graphics processing unit (GPU) parallelization during three-dimensional (3D) finite-difference time-domain (FDTD) simulation, the system comprising:
a GPU;
a central processing unit (CPU) comprising one or more processors; and
memory storing executable instructions that, when executed by the one or more processors, cause the system to:
before running the 3D FDTD simulation:
create, by the CPU, a plurality of 3D arrays;
create, by the CPU, a mirror set of the plurality of 3D arrays; and
store, by the CPU, the mirror set on the GPU;
during runtime of the 3D FDTD simulation:
send, from the CPU to the GPU, instructions to update arrays of interest of the mirror set on the GPU; and
upon completion of the 3D FDTD simulation:
copy, by the CPU, the updated arrays of interest from the GPU to the CPU; and
write, by the CPU to an output file, the updated arrays of interest.

11. The system of claim 10, wherein execution, by the one or more processors, of the executable instructions to create the plurality of 3D arrays further causes the system to:
create, by the CPU, a first 3D array, wherein creating the first 3D array comprises determining at least one of a plurality of grids;
create, by the CPU, a first pointer to the first 3D array;
allocate, by the CPU, a first portion of random-access memory (RAM) of the system for the first 3D array; and
store, by the CPU in the RAM, the first 3D array in the first portion of the RAM identified by the first pointer.

12. The system of claim 11, wherein execution, by the one or more processors, of the executable instructions to create the mirror set further causes the system to:
create, by the CPU on the GPU, a second pointer to the first 3D array referred to by the first pointer;
create, by the CPU on the GPU, a first mirror 3D array pointed to by the second pointer; and
copy, by the CPU to the GPU, data in the first 3D array pointed to by the first pointer to the first mirror 3D array pointed to by the second pointer.

13. The system of claim 10, wherein execution, by the one or more processors, of the executable instructions further causes the system to:
identify, by the CPU, the arrays of interest comprising at least one array of the plurality of 3D arrays that is used in the 3D FDTD simulation;
identify, by the CPU, a quantity of arrays in the arrays of interest; and
identify, by the CPU, a quantity of elements in the arrays of interest.

14. The system of claim 13, wherein execution, by the one or more processors, of the executable instructions to update the arrays of interest of the mirror set further causes the system to:
communicate, by the CPU to the GPU, the quantity of arrays, the quantity of elements, and an instruction to update simulation data in the arrays of interest in any order according to operations of the 3D FDTD simulation,
wherein execution of the executable instructions to update the simulation data in the arrays of interest further causes the system to update array elements of each 3D electromagnetic field component of each array in the arrays of interest.

15. The system of claim 11, wherein execution, by the one or more processors, of the executable instructions to copy the updated arrays of interest from the GPU to the CPU further causes the system to:
send, by the CPU, an exit instruction to the GPU to copy the updated arrays of interest from the GPU to corresponding mirror arrays pointed to on the RAM.

16. The system of claim 14, wherein the updated simulation data on the GPU is copied to RAM of the system only upon the completion of the 3D FDTD simulation.

17. A non-transitory computer-readable medium for circumventing bottlenecking of graphics processing unit (GPU) parallelization during three-dimensional (3D) finite-difference time-domain (FDTD) simulation, the non-transitory computer-readable medium storing executable instructions, that, when executed by one or more processors of a computer system comprising a GPU and a central processing unit (CPU), cause the computer system to:
before running the 3D FDTD simulation:
create, by the CPU, a plurality of 3D arrays;
create, by the CPU, a mirror set of the plurality of 3D arrays; and
store, by the CPU, the mirror set on the GPU;
during runtime of the 3D FDTD simulation:
send, from the CPU to the GPU, instructions to update arrays of interest of the mirror set on the GPU; and
upon completion of the 3D FDTD simulation:
copy, by the CPU, the updated arrays of interest from the GPU to the CPU; and
write, by the CPU to an output file, the updated arrays of interest.

18. The non-transitory computer-readable medium of claim 17, wherein the executable instructions, when executed by the one or more processors, further cause the computer system to:
for creating the plurality of 3D arrays:
create, by the CPU, a first 3D array, wherein creating the first 3D array comprises determining at least one of a plurality of grids;
create, by the CPU, a first pointer to the first 3D array;
allocate, by the CPU, a first portion of random-access memory (RAM) of the computer system for the first 3D array; and
store, by the CPU in the RAM, the first 3D array in the first portion of the RAM identified by the first pointer; and
for creating the mirror set:
create, by the CPU on the GPU, a second pointer to the first 3D array referred to by the first pointer;
create, by the CPU on the GPU, a first mirror 3D array pointed to by the second pointer; and
copy, by the CPU to the GPU, data in the first 3D array pointed to by the first pointer to the first mirror 3D array pointed to by the second pointer.

19. The non-transitory computer-readable medium of claim 17, wherein the executable instructions, when executed by the one or more processors, further cause the computer system to:
identify, by the CPU, the arrays of interest comprising at least one array of the plurality of 3D arrays that is used in the 3D FDTD simulation;
identify, by the CPU, a quantity of arrays in the arrays of interest; and
identify, by the CPU, a quantity of elements in the arrays of interest.

20. The non-transitory computer-readable medium of claim 19, wherein to update the arrays of interest of the mirror set, the executable instructions, when executed by the one or more processors, further cause the computer system to:
communicate, by the CPU to the GPU, the quantity of arrays, the quantity of elements, and an instruction to update simulation data in the arrays of interest in any order according to operations of the 3D FDTD simulation,
wherein execution of the executable instructions to update the simulation data in the arrays of interest further causes the computer system to update array elements of each 3D electromagnetic field component of each array in the arrays of interest, and
wherein the updated simulation data on the GPU is copied to RAM of the computer system only upon the completion of the 3D FDTD simulation.
